(19) United States
(12) Patent Application Publication
(10) Pub. No.: US 2002/0075323 A1
(43) Pub. Date: Jun. 20, 2002

(54) System and method for using real-world images for providing routing directions

(76) Inventor: Robert B. O'Dell, Oakland, CA (US)

Correspondence Address: Ararat Kapouytian, Marrison & Foerster LLP, 425 Market Street, San Francisco, CA, 94105-2482, US

(21) Appl. No.: 09/796,989

(22) Filed: Feb. 28, 2001

Related U.S. Application Data
(60) Provisional application No. 60/185,256, filed on Feb. 28, 2000.

(51) Int. Cl. G09G 5/00

(52) U.S. Cl. 345/835

(57) ABSTRACT

The present invention relates to a method and apparatus for using images, text files, video files, and/or audio files to aid navigation an unfamiliar area.

### RELATED APPLICATIONS

This application claims the benefit of U.S. Provisional Application No. 60/185,256 filed Feb. 28, 2000.

### TECHNICAL FIELD

The present information relates to a system and method for using images and other media to aid navigation and provide routing directions.

### BACKGROUND ART

With the recent advent of mobile computer devices, electronic versions of city maps are now available as screen displays. There are, however, several inherent problems with such displays. One is that small screen size often means that any map covering a large area of the city is difficult to read and the displays covering smaller areas are difficult to comprehend. Another is a problem presented with all maps: the user must properly orient the map in order to strike out in the proper direction, a situation which many people find confusing because many maps are only abstractions of the actual cityscape.

What is desired is an improved system and method for efficiently aiding navigation in an unfamiliar area.

### SUMMARY OF THE INVENTION

The present invention provides a novel system and method for using images such as photographs, sketches, video, and/or text as navigation aids.

In one aspect of the invention, a method is provided for aiding navigation to or from a location by retrieving from electronic memory a set of files containing images related to the location, and displaying the images to the user on an electronic display screen.

In a further aspect of the invention, a wide scale image of a location is associated with links to more detailed smaller scale images of locations encompassed within the wider scale image.

In another aspect of the invention, a novel system and method are provided aids in navigating about an urban or a nonurban area by navigating among a collection of linked images of varying scales and perspectives of the area to be navigated and of objects such as buildings and landmarks visible within those areas.

Another aspect of the invention provides a method for aiding navigation in which a system associated with a server and a database receives a first request from a user, wherein the first request is associated with a starting location. The system receives a second request from the user, wherein the second request is associated with a destination location. A set of image files related to a path between the starting location and the destination location is retrieved from the system. The image files are displayed to the user.

### BRIEF DESCRIPTION OF THE DRAWINGS

FIG. 1 shows an exemplary overview of a navigation aiding system and method of an embodiment of the present invention.

FIG. 2 shows an exemplary embodiment of a visual display associated with a user computer of the system and method of the present invention.

FIG. 3A shows an exemplary embodiment of a introductory page that displays a subject routing area in accordance with a present embodiment of the invention.

FIG. 3B shows another exemplary embodiment of a introductory page that displays a subject routing area in accordance with a present embodiment of the invention.

FIG. 4 shows an exemplary page displaying a street map of the subject routing area of FIGS. 3A and 3B.

FIG. 5 shows an exemplary page displaying eye-level views of an area selected from FIG. 4 by a user of the system and method of an embodiment of the present invention.

FIG. 6 shows an exemplary page displaying a larger view of an eye-level view for an area selected from FIG. 5 by the user.

FIG. 7 shows an exemplary page displaying a more detailed picture of the larger view of an area shown in FIG. 6.

FIG. 8 shows an exemplary page displaying detailed frontal view of a location selected from FIG. 7 by the user.

FIG. 9A shows an exemplary page displaying of permitted starting locations within a subject routing area in accordance with a present embodiment of the invention.

FIG. 9B shows another exemplary page displaying permitted starting locations within a subject routing area in accordance with a present embodiment of the invention.

FIG. 10 shows an exemplary page displaying destination locations associated with a selected starting location within the subject routing area in accordance with a present embodiment of the invention.

FIGS. 11-12 show exemplary HTML code for pages associated with an exemplary embodiment of the present invention.

### DETAILED DESCRIPTION OF THE PREFERRED EMBODIMENT

The present invention provides a method and apparatus for using images, text files, video files, and/or audio files as geographic navigation aids. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

The method and system of the present invention provides a navigation aid for geographic areas, such as urban, suburban, or rural areas and even inside buildings, by communicating images to a user attempting to navigate the area.

### EXAMPLE #1

User Has No Specific Destination

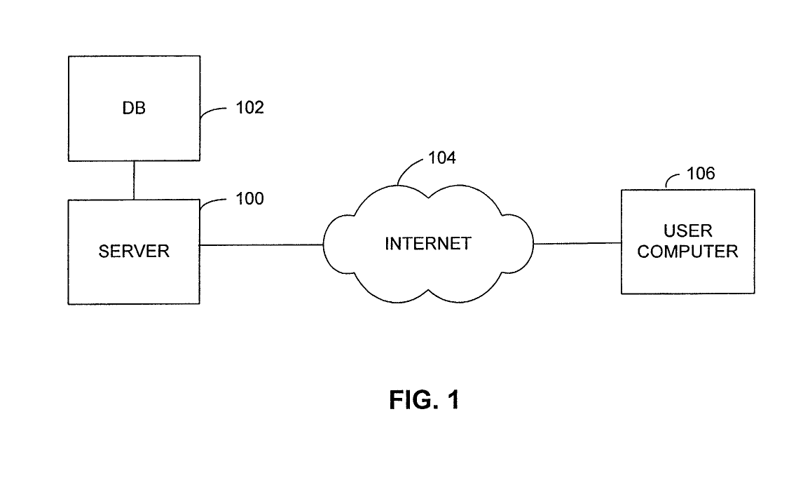

FIG. 1 is an illustrative block diagram of a system that can be used as a navigation aiding system in accordance with the present invention. Server 100 is associated with database (DB) 102. Server 100 may be linked to user computer 106 through a network, such as the Internet 104. HTML pages containing links to associated files, such as but not limited to image files, may be stored on database 102. User computer 106 may be, for example, a personal computer, a laptop computer, or any mobile device capable of storing files and displaying images, such as photographs or words displayed on street signs or buildings. In an embodiment of the invention, a user associated with user computer 106 may download the needed HTML pages for a subject route from a routing web site, load it into his user computer 106 via a portable storage or memory device. In another embodiment of the invention, the user may also choose to receive the pages by wireless modem as the user walks along an unfamiliar route for which navigation aid is desired.

In an embodiment, an administrator of the server may prepare these HTML pages and take photos of the streets, intersections, buildings, business fronts and any other points of interest within the subject area. These photos may be, for example, eye-level, still photos. The administrator may also prepare other files such as video, audio, and text files relevant to particular images, landmarks, or locations. Exemplary text files may include representations of words such as those found on street signs or buildings found along a route associated with the subject location, image, or landmark. The subject area may be, for example, an area of a city or urban area that is of particular interest to tourists or business visitors. In an embodiment of the invention, the administrator may either capture the images by a digital camera, or otherwise digitize them for computer storage, such as in database 102. The administrator may then create routes within the subject area, and create a walking or travel guide by selecting appropriate images and arranging them in the DB 102 in an order consistent with each desired route. In an embodiment of the invention, the administrator may use and create an unlimited number of routes, images, and corresponding files.

In another embodiment of the invention, other languages and programming methods may be used to create such linked files. For example, Wireless Macro Language [WML] may be used to create HTML pages available for display via small screen and wireless systems, such as but not limited to cellular phones and mobile devices. In an embodiment, WML documents may also be hyperlinked to allow for quick movement between the documents. In another embodiment of the invention, Microsoft PowerPoint may be used to link the files. It will be appreciated that any system or language that allows for file linking may be used by an embodiment of the present invention.

In an embodiment of the invention, a user may download image files from the server database via the Internet. In an embodiment of the invention, the images, pages, and associated files may be loaded into user computer 106 by the manufacturer, added as application software by a user associated with user computer 106, or downloaded from the Internet 104. These HTML pages and associated files may also be communicated to user computer 106 via a web site set up on server 100 that accesses database 102. There exists computer program code that implements display of the HTML pages and associated files, such as the image files. Upon receiving a selection of a location from the user, user computer 106 may retrieve a set of image files and display them on a computer display to the user. Image files may be representations of images in a digitized format. Image files may include, for example, photograph files, sketch files, video files, and/or text files.

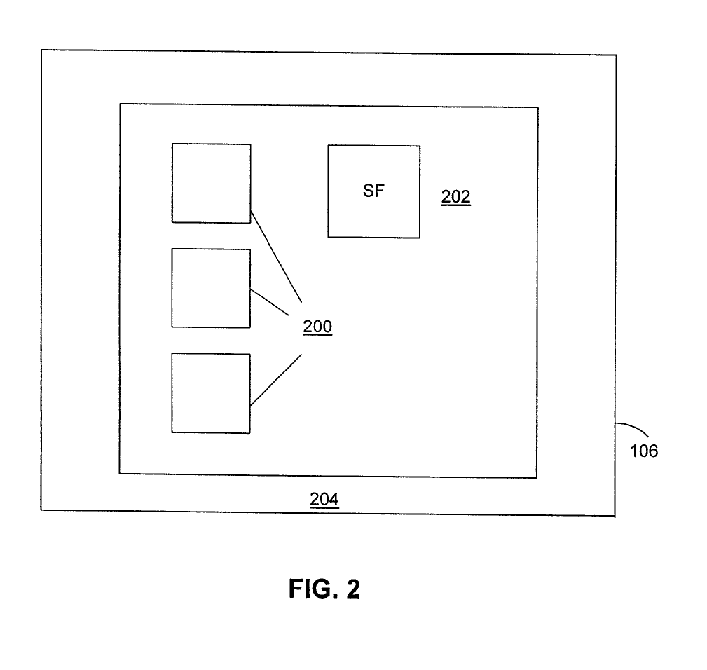

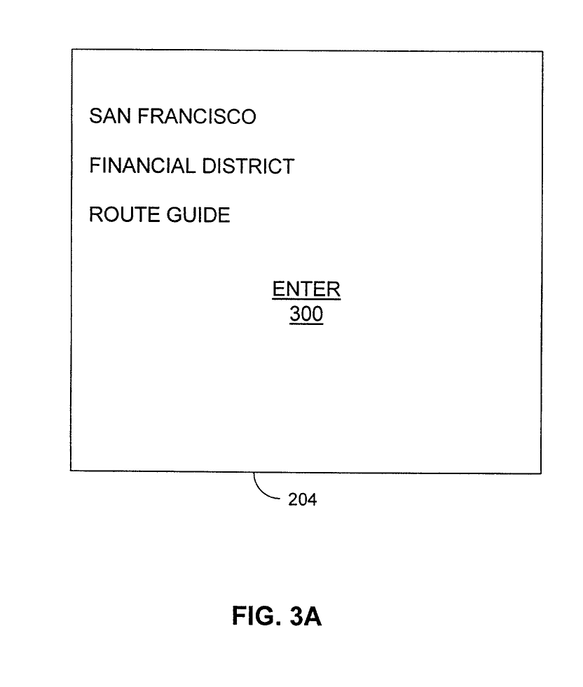

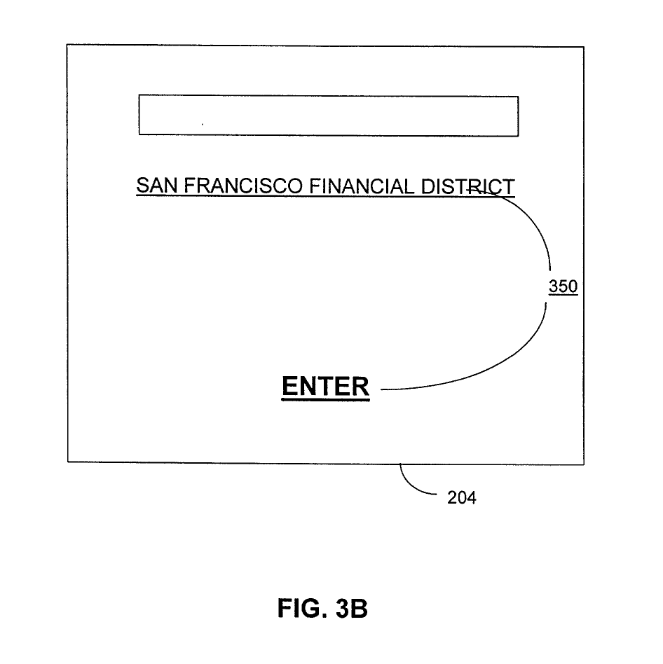

A user may have no specific destination or route in mind but wish to become oriented with the subject area and select a route or direction for travel. FIG. 2 shows an exemplary embodiment of a visual display 204 provided by a user computer 106 in accordance with a present embodiment of the invention. Various icons 200 may be located on the display 204. Icons 200 may be, for example, associated with shortcuts to executable programs or files. The user may select SF 202, which may be an icon with a shortcut to a stored HTML page on user computer 106. In another embodiment of the invention, SF 202 may also be accessed over a network such as the Internet. Upon selecting SF 202, the user may be shown a screen such as the San Francisco Financial District Route Guide screen on display 204 in FIG. 3A.

FIG. 3A shows an exemplary embodiment of a page that displays the name of the subject routing area and the word ENTER 300, which can be a hypertext link. The user may select ENTER, which is a link to the next page in sequence. In another embodiment of the invention, sequential images may be displayed on the same web page, rather than on different web pages.

In an embodiment of the invention, referring again to FIG. 2, upon selecting SF 202, the user may also be shown a screen such as the subject routing area screen on display 204 in FIG. 3B. FIG. 3B shows another exemplary embodiment of a page that displays the name of the subject routing area. Hypertext links 350 prompt the user to progress to a subsequent page in the navigation aid of the present invention.

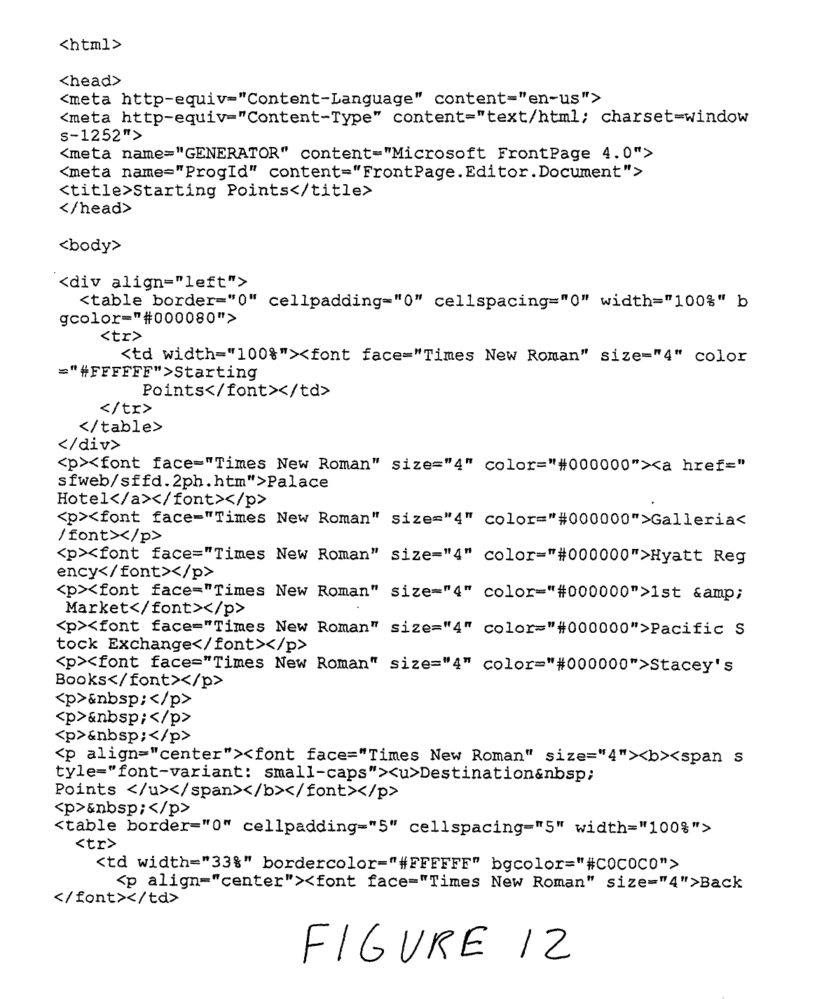

FIG. 11 shows an exemplary embodiment of HTML code for a screen such as the one shown in FIG. 3B. It will be appreciated that upon viewing FIGS. 3-10, one of ordinary skill in the art would be able to program such screens containing the corresponding links and files without undue experimentation. One of ordinary skill in the art would also be able to program variations of these screens without undue experimentation. Therefore, the code shown in FIG. 11 is only for exemplary purposes. Referring to FIG. 11, an administrator may perform the coding using commercial programs such as Microsoft Front Page or any other of a number of other commercially available programs. In an embodiment, such coding may also be performed manually without the use of such programs by one of ordinary skill in the art.

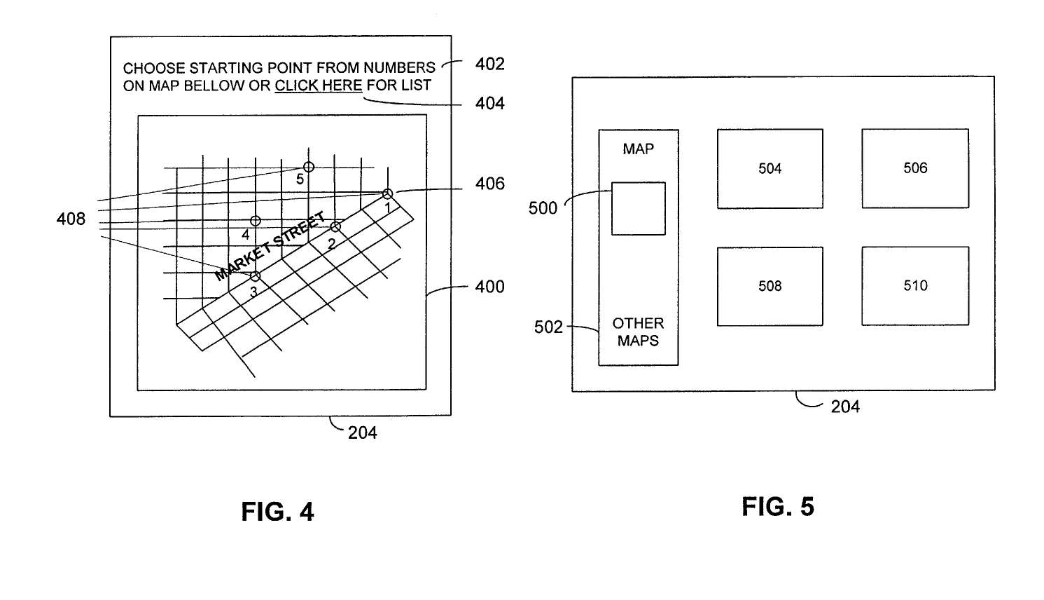

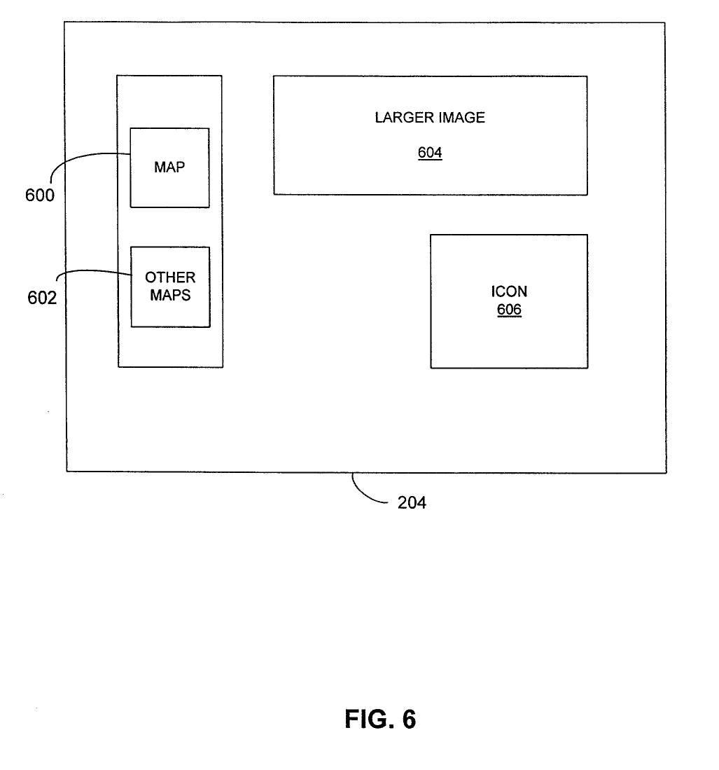

Referring again to FIG. 3A, upon selecting ENTER 300, an HTML page such as the one shown in FIG. 4 may be communicated to the user. FIG. 4 shows, for example, a street map 400 of the San Francisco Financial District with number links 408 at various places within the map. Each number may represent a route starting point that is available associated with prepared HTML file sequences. Instruction Area 402 may prompt the user to choose a starting point from the number links 408 shown on map 400 or to select LIST LINK 404 to be shown a list of starting points. In an embodiment, the user may select number link 406, which is a link to a specific area or intersection, such as the street intersection of Market and First streets in San Francisco. A screen such as the one shown in exemplary FIG. 5 may then be communicated to the user.

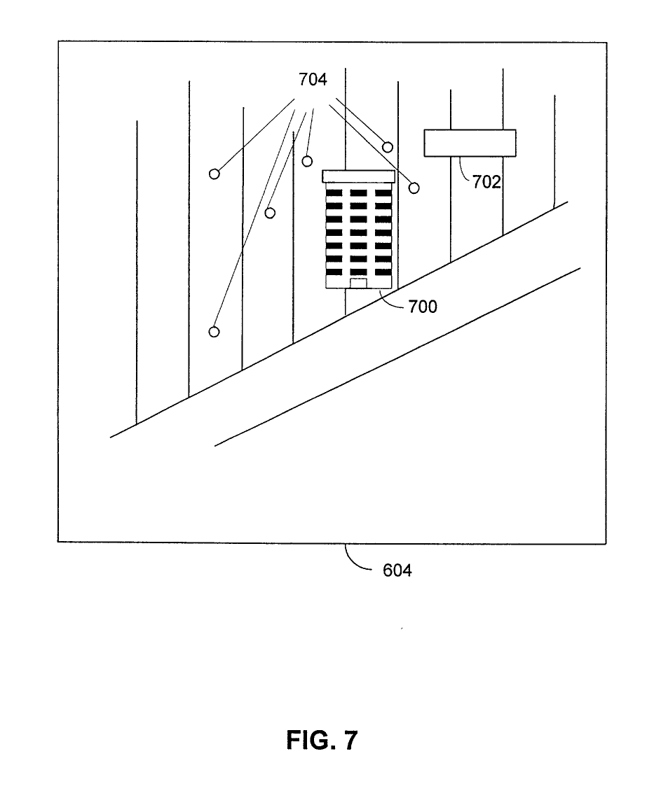

FIG. 5 shows an exemplary embodiment of an HTML or web page having four eye-level views 504, 506, 508, and 510 of the area around the selected street intersection, such as Market and First streets. The user may also be shown a map 500 of the streets immediately surrounding the subject area, along with hypertext links to other maps 502 related to the subject area. The user may then be prompted to select between images 504, 506, 508, and 510, in order to show a view of the direction he intends to use as a beginning point. Image 504 may show, for example, a view of a northern direction associated with the subject area. Image 506 may show, for example, a view of an eastern direction associated with the subject area. Image 508 may show, for example, a view of a western direction associated with the subject area. Image 510 may show, for example, a view of a southern direction associated with the subject area. If the user selects, for example, image 504, a screen or web page such as the one shown in FIG. 6 may be communicated for display to the user.

FIG. 6 shows an exemplary page displaying a larger view of an eye-level view selected by the user. The screen shown in FIG. 6 may include both a partial map 600 of the subject area and a larger image 604 of the view shown in the previously selected image 504. This screen may also contain an icon 606 that shows the location and direction of the user's route at this point. This direction and location may be based on the selected image 504 from the screen shown in FIG. 5. In an embodiment of the invention, map 600 and other maps 602 may contain number links. Map 600 may be, for example, a map associated with a location previously selected by the user, a larger view of the subject location, or a view of a starting location. Other maps 602 may contain hypertext links to maps of other areas of potential interest for the user. Number links may be, for example, hypertext links having numbers associated with them. The number links may be overlayed directly on the map or may appear in a pull down menu. If the user selects one of these number links, the user may view out-of-sequence views and maps relating to the location associated with the selected number link.

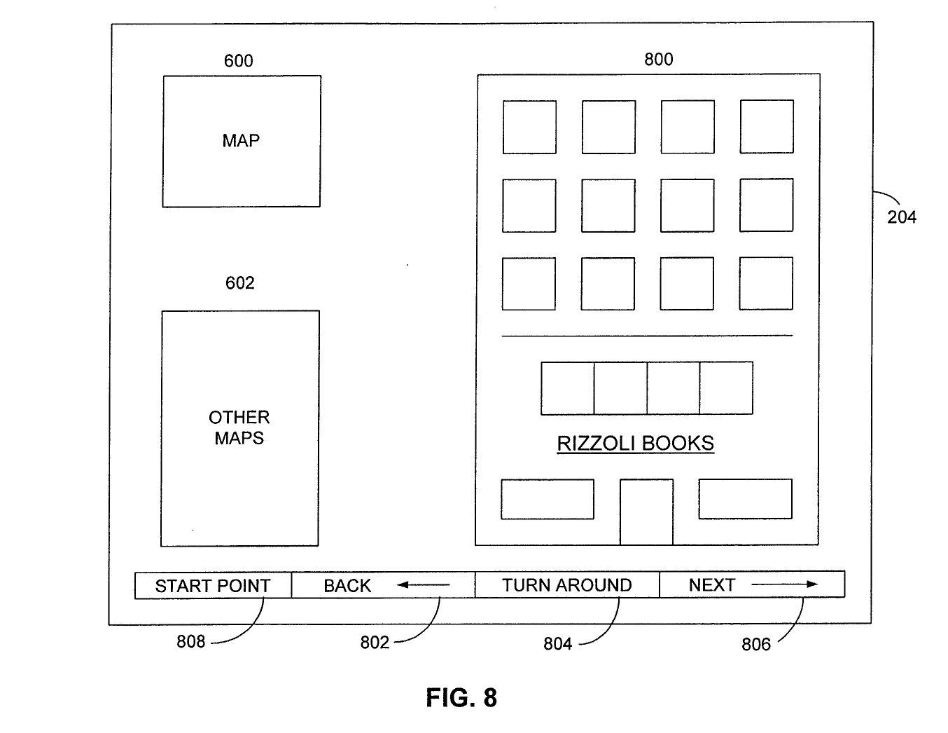

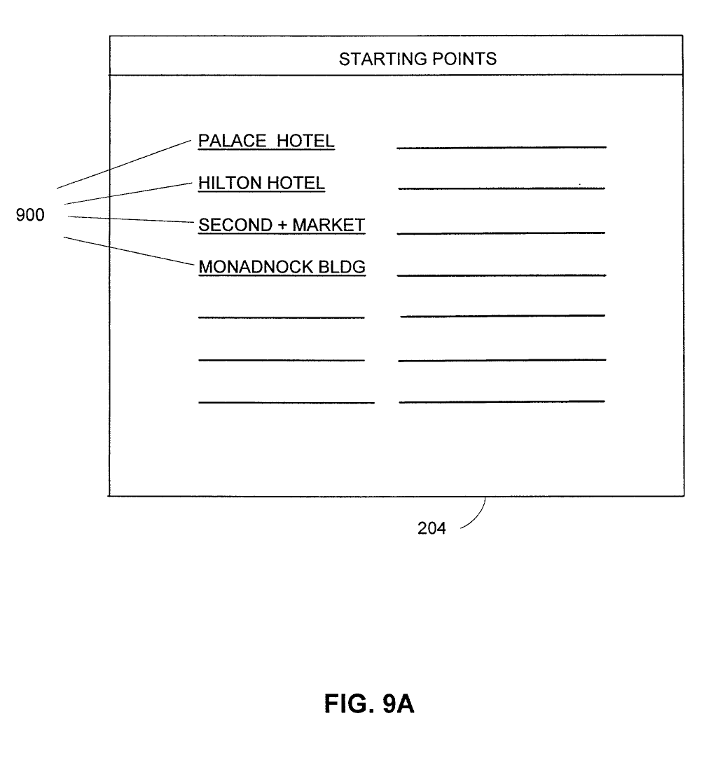

FIG. 7 shows an exemplary page displaying a detailed view of larger image 604. Links 704, 702, and 700 may be present at various places of larger image 604. These links 704, 702, and 700 may be associated with such landmarks as buildings and businesses. By selecting one of these links, such as link 700, a screen or HTML page such as the one shown in FIG. 8 may be communicated to the user.

FIG. 8 shows an exemplary page displaying a detailed frontal view of a subject location selected by the user. For example, image 800 may show an image of the building housing The Pacific Stock Exchange. The image in FIG. 8, for instance, is provided when the user selects a prescribed one of the links 704 in FIG. 7. Image 800 may contain various links, such as hypertext links. By selecting one of these links, information relating to that portion of the image may be communicated for display to the user. This information may be, for example, a text file, an audio file, or a video file. If a link is associated with a restaurant, for example, when the user selects the link, a menu for the restaurant may be displayed to the user.

A navigation bar at the bottom of the screen may contain links such as start point 808, back 802, turn around 804, and next 806. If the user selects NEXT 806 from the underlined text at the bottom of the page, the user may be shown the next image in sequence that continues along the desired route of the user. If the user selects BACK 802, a previous screen such as the one shown in FIG. 7 may be communicated for display to the user. If the user selects TURN AROUND 804, images of views along the same streets taken from the opposite direction may be communicated to the user so that the user may attempt to retrace his or her steps along the same route. If the user selects START POINT 808, a larger subject area map, such as the screen shown in FIG. 5, may be displayed to the user.

### EXAMPLE NUMBER #2

User Selects a Destination

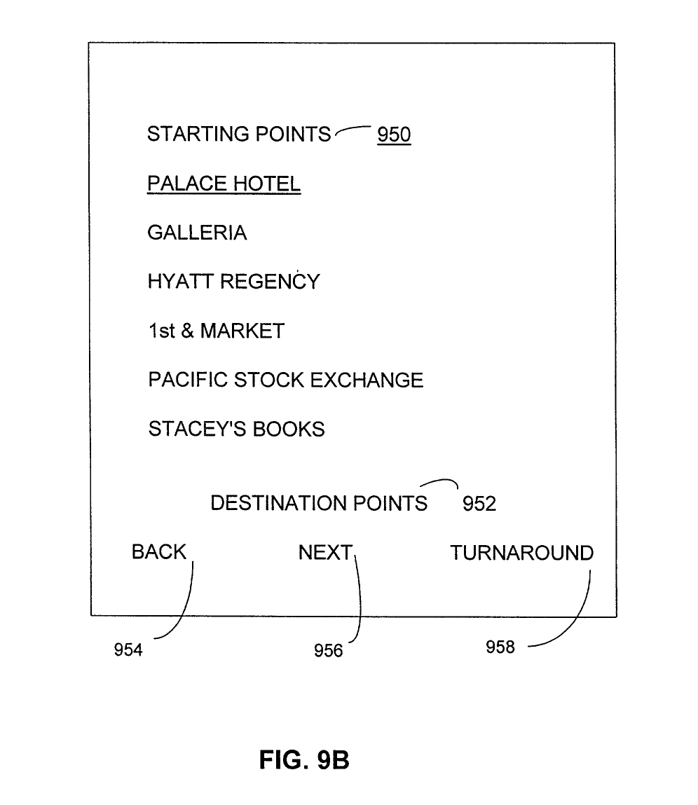

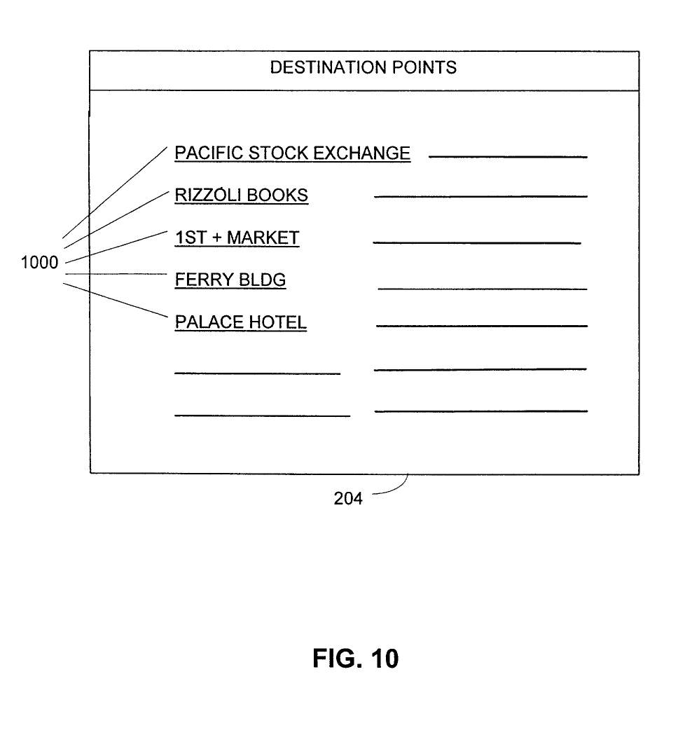

In another embodiment of the invention, the user may select a starting point and a destination point for travel. Referring to FIG. 4, if the user selects link 404, a screen or HTML page such as the one shown in FIG. 9A may be communicated for display to the user.

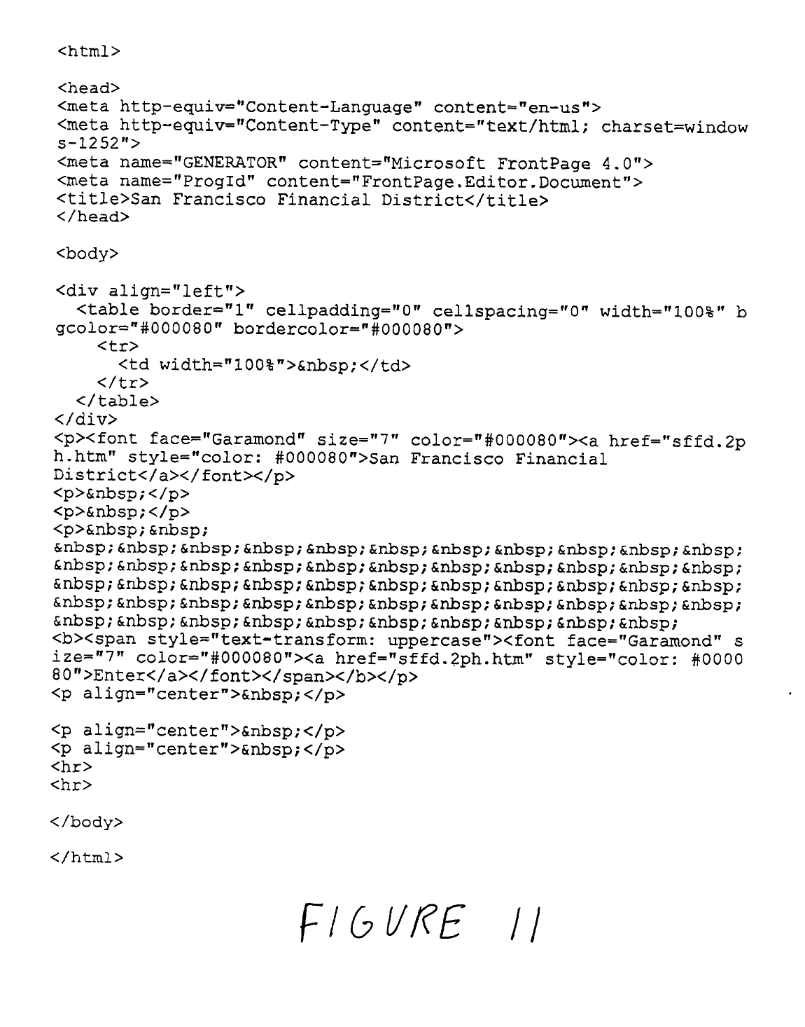

FIG. 9A shows an exemplary page displaying possible starting locations 900 within an area such as the San Francisco Financial District. If the user selects a starting location 900, a screen such as the one shown in FIG. 10 may be communicated for display to the user. FIG. 10 shows a list of exemplary destination locations 1000 associated with a selected starting location in the subject routing area. In an embodiment of the invention, each starting location 900 shown in FIG. 9A may be associated with a group of sequentially linked HTML page files for each available destination location 1000 shown in FIG. 10. In an embodiment, for each starting location, there may be an equal number of routes as there are destination locations, along with an equal number of sets of linked HTML destination route files. In an Internet environment, all of these files may be downloaded from the Internet to a user computer associated with the user of the invention.

In an embodiment of the invention, after selecting a starting location and a destination location, screens showing images associated with paths of travel from the starting location to the destination location may be communicated to the user. such as but not limited to screens comparable to the exemplary ones shown in FIGS. 4-8. In an embodiment, the user retains the full range of options, such as but not limited to selecting different routes based on the various image files, selecting larger images associated with specific images, viewing various maps associated with the selected path of travel, and viewing image files and other files associated with areas and landmarks. The user may also select links to turn around, return to the user's starting location, or to proceed to a next screen or back to a previous screen.

In an embodiment of the invention, referring again to FIG. 9A, each starting location 900 may have a different set of destination locations associated with it. In an embodiment, images are successively communicated or available to the user in a sequential manner to allow the user to successfully navigate from the selected starting location to the selected destination.

FIG. 9B shows another exemplary page displaying permitted starting locations within a subject routing area. The invention may prompt the user to select a starting location link 950. Upon selecting a starting location link 950, the user may be shown a page containing destination location links, such as but not limited to the page shown in FIG. 10. Referring again to FIG. 9B, the user may also directly view destination locations by selecting link 952. In an embodiment, the user may also select links such as back 954, next 956, and turn around 958. FIG. 12 shows exemplary HTML code for a page such as the one seen in FIG. 9B. Again, it will be appreciated that upon seeing FIG. 9B, one of ordinary skill in the art would be able to program the screen or variations of it without undue experimentation.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

What is claimed is:

1. A method for providing navigation aid comprising:
receiving a request from a user for navigation aid, wherein the request is associated with a location;
retrieving a set of one or more image files related to the location; and
displaying the set of one or more image files to the user on a computer display.

2. The method of claim 1, wherein the location is an urban location.

3. The method of claim 1, wherein the set of one or more image files is retrieved from a user computer.

4. The method of claim 1, wherein the set of one or more image files is retrieved from a database associated with a server.

5. The method of claim 1, wherein the set of one or more image files are displayed on a browser interface at a user computer.

6. The method of claim 1, wherein the set of one or more image files contains at least one member selected from the group consisting of a photograph file, a sketch file, a video file, and a text file.

7. The method of claim 1, wherein the set of one or more image files are associated with one or more eye-level views associated with the location.

8. A method for providing navigation aid comprising:
receiving a first request from a user, wherein the first request is associated with a starting location;
receiving a second request from the user, wherein the second request is associated with a destination location;
retrieving a set of one or more image files related to a path between the starting location and the destination location; and
displaying the set of one or more image files to the user on a computer display.

9. The method of claim 8, wherein the starting location is a first urban location and the destination location is a second urban location.

10. The method of claim 8, wherein the set of one or more image files is retrieved from a user computer.

11. The method of claim 8, wherein the set of one or more image files is retrieved from a database associated with a server.

12. The method of claim 8, wherein the set of one or more image files are displayed on a browser interface at a user computer.

13. The method of claim 8, wherein the set of one or more image files contains at least one member selected from the group consisting of a photograph file, a sketch file, a video file, and a text file.

14. The method of claim 8, wherein the set of one or more image files are associated with one or more eye-level views associated with the path between the starting location and the destination location.

15. The method of claim 1, further comprising communicating an audio file to the user, wherein the audio file is associated with the location.

16. The method of claim 8, further comprising communicating an audio file to the user, wherein the audio file is associated with the path between the starting location and the destination location.

17. A computer program product for use with a system for aiding navigation, said computer program product comprising:
a computer useable medium including computer readable program code means embodied in said medium for causing aiding navigation, said computer program product including:
(a) computer readable program code means for causing a computer to effect receiving a request from a user for navigation aid, wherein the request is associated with a location;
(b) computer readable program code means for causing the computer to retrieve a set of one or more image files related to the location; and
(c) computer readable program code means for causing the computer to display the set of one or more image files to the user on a computer display.

18. An article of manufacture comprising:
a computer useable medium including computer readable program code embodied therein for causing aiding navigation, the computer readable program code in said article of manufacture comprising:
(a) computer readable program code means for causing a computer to effect receiving a request from a user for navigation aid, wherein the request is associated with a location;
(b) computer readable program code means for causing the computer to retrieve a set of one or more image files related to the location; and
(c) computer readable program code means for causing the computer to display the set of one or more image files to the user on a computer display.

19. A computer program product for use with a system for aiding navigation, said computer program product comprising:
a computer useable medium including computer readable program code means embodied in said medium for causing aiding navigation, said computer program product including:
(a) computer readable program code means for causing a computer to effect receiving a first request from a user, wherein the first request is associated with a starting location;
(b) computer readable program code means for causing the computer to receive a second request from the user, wherein the second request is associated with a destination location; and
(c) computer readable program code means for causing the computer to retrieve a set of one or more image files related to a path between the starting location and the destination location; and
(d) computer readable program code means for causing the computer to display the set of one or more image files to the user on a computer display.

20. An article of manufacture comprising:
a computer useable medium including computer readable program code embodied therein for causing aiding navigation, the computer readable program code in said article of manufacture comprising:
(a) computer readable program code means for causing a computer to effect receiving a first request from a user, wherein the first request is associated with a starting location;
(b) computer readable program code means for causing the computer to receive a second request from the user, wherein the second request is associated with a destination location; and
(c) computer readable program code means for causing the computer to retrieve a set of one or more image files related to a path between the starting location and the destination location; and
(d) computer readable program code means for causing the computer to display the set of one or more image files to the user on a computer display.

21. The method of claim 6, wherein the text file is associated with one or more words, wherein the one or more words are associated with at least one member selected from the group consisting of a street sign and a building, wherein the at least one member selected from the group consisting of a street sign and a building is associated with a route associated with the location.

22. The method of claim 6, wherein the sketch file comprises a map.

23. The method of claim 6, wherein the sketch file comprises a sketched image of a view associated with a route associated with the location.

24. A method for providing navigation aid comprising:
receiving a first request from a user for navigation aid, wherein the request is associated with a location;
retrieving a first image file related to the location;
retrieving a second image file related to the location, wherein the second image file is a larger view of the first image file;
displaying the first image file to the user on a computer display;
receiving a second request from the user, wherein the second request is associated with the first image file displayed to the user; and
displaying the second image file to the user on the computer display.

25. A method for providing navigation aid comprising:
receiving a first request from a user for navigation aid, wherein the request is associated with a first location;
retrieving a first image file associated with a view of the first location;
retrieving a second image file associated with a view of a second location, wherein the view of the second location is associated with a path of travel from the first location to the second location;
displaying the first image file to the user on a computer display;
receiving a second request from the user for navigation aid; and
displaying the second image file to the user on the computer display.

26. A method for providing navigation aid comprising:
receiving a first request from a user for navigation aid, wherein the request is associated with a first location;
retrieving a first image file associated with a view of the first location;
retrieving a second image file associated with a view of a second location, wherein the view of the second location is associated with a path of travel from the first location to the second location;
retrieving a third image file, wherein the third image file is associated with a view of a path of travel from the second location to the first location;
displaying the first image file to the user on a computer display;
receiving a second request from the user for navigation aid;
displaying the second image file to the user on the computer display;
receiving a third request from the user for navigation aid; and
displaying the third image file to the user on the computer display.

27. A method for providing navigation aid comprising:
receiving a request for navigation aid, wherein the request is associated with a location;
displaying a map, wherein the map is associated with the location, and wherein the map contains a plurality of links, wherein the plurality of links are associated with starting locations for travel;
receiving a selection of one of the plurality of links;
retrieving at least one image file associated with selected link;
displaying the at least one image file on a computer display.

28. The method of claim 27, wherein the selected link is associated with a specific area or intersection, and wherein the at least one image file is associated with at least one eye-level view of the specific area or intersection.

29. A method for providing navigation aid comprising:
receiving a first request from a user for navigation aid, wherein the request is associated with a location;
retrieving a first image file related to the location;
retrieving a second image file related to the location, wherein the second image file is a larger view of the first image file, and wherein the second image file contains one or more links associated with one or more landmarks;
retrieving a third image file, wherein the third image file is associated with a view associated with at least one of the one or more landmarks.
displaying the first image file to the user on a computer display;
receiving a second request from the user, wherein the second request is associated with the first image file displayed to the user;
displaying the second image file to the user on the computer display;
receiving a selection of at least one of the one or more links; and
displaying the third image file to the user on the computer display.
